(19) United States
(12) Patent Application Publication
(10) Pub. No.: US 2016/0225339 A1
(43) Pub. Date: Aug. 4, 2016

(54) METHODS OF PROCESSING IMAGES IN ELECTRONIC DEVICES

(71) Applicant: SAMSUNG ELECTRONICS CO., LTD., Suwon-si (KR)

(72) Inventors: Hyun-Cheol Kim, Yongin-si (KR); Young-Gwan Kim, Seoul (KR); Ji-Yun Kim, Suwon-si (KR); Keon-Joo Lee, Seoul (KR); You Sub Jung, Seongnam-si (KR)

(21) Appl. No.: 14/982,660

(22) Filed: Dec. 29, 2015

(30) Foreign Application Priority Data
Feb. 2, 2015 (KR) 10-2015-0015829

(51) Int. Cl. G09G 5/00; G06T 1/20

(52) U.S. Cl. CPC G09G 5/006; G06T 1/20; G09G 2320/041; G09G 2340/0435

(57) ABSTRACT

A method for processing images includes displaying a first image rendered by a graphic processing unit on a display panel, collecting at least one temperature data of at least one measurement point of the display panel or a host device, and adaptively adjusting an updating frequency of a second image based on the collected at least one temperature data. The second image is to be displayed on the display panel subsequent to the first image.

### CROSS-REFERENCE TO RELATED APPLICATION

Korean Patent Application No. 10-2015-0015829, filed on Feb. 2, 2015, and entitled, “Methods of Processing Images in Electronic Devices,” is incorporated by reference herein in its entirety.

### BACKGROUND

1. Field

One or more embodiments described herein relate methods for processing images in electronic devices.

2. Description of the Related Art

The development of application and other high-speed processors continues to be of interest. When a processor operates at a high speed, heat is generated which may cause the host device to operate abnormally. Also, the user of the host device may suffer burns, which is more likely to happen for smaller sized devices. These difficulties may be addressed by lowering the operating speed of the processor. However, such an approach may limit data processing capacity.

### SUMMARY

In accordance with one or more embodiments, a method for processing images in an electronic device which includes a graphic processing unit (GPU), the method comprising displaying a first image rendered by the GPU on a display panel; collecting, by a display control module (DCM), at least one temperature data of at least one measurement point of the electronic device; and adaptively adjusting, by the DCM, an updating frequency of a second image based on the collected at least one temperature data, the second image to be displayed on the display panel subsequent to the first image. Adaptively adjusting the updating frequency of the second image may include comparing the at least one temperature data with at least one reference data; and increasing or decreasing, by the DCM, the updating frequency of the second image according to a result of the comparison.

The method may include delaying, by the DCM, updating the second image to decrease the updating frequency of the second image when the at least one temperature data is substantially equal to or greater than the at least one reference data.

The method may include stop delaying updating, by the DCM, the second image to decrease the updating frequency of the second image when the at least one temperature data is smaller than the at least one reference data.

The method may include storing rendered images in an internal buffer in the DCM; and adjusting, by the DCM, the updating frequency of the second image by adjusting a consumption speed of the rendered second image from the internal buffer to the display panel.

The method may include decreasing, by the DCM, consumption speed of the rendered second image from the internal buffer to the display panel when the at least one temperature data is substantially equal to or greater than the at least one reference data.

The method may include increasing, by the DCM, consumption speed of the rendered second image from the internal buffer to the display panel when the at least one temperature data is smaller than the at least one reference data. The at least one reference data may include a first reference data and a second reference data greater than the first reference data.

The method may include adjusting, by the DCM, the updating frequency of the second image so that the GPU renders input image data with a first frequency per unit time when the at least one temperature data is smaller than the first reference data.

The method may include adjusting, by the DCM, the updating frequency of the second image so that the GPU renders the input image data with a second frequency smaller than the first frequency per unit time, when the at least one temperature data is substantially equal to or greater than the first reference data and is smaller than the second reference data.

The method may include adjusting, by the DCM, the updating frequency of the second image so that the GPU renders the input image data with a third frequency smaller than the second frequency per unit time, when the at least one temperature data is substantially equal to or greater than the second reference data.

When the GPU receives an external input instead of input image data while the DCM adjusts the updating frequency of the second image such that the GPU renders the input image data with an adjusted frequency smaller than a first frequency per unit time, the DCM may adjust the updating frequency of the second image such that the GPU renders the external input with the first frequency.

The at least one temperature data may include a plurality of temperature data of a plurality of measurement points of the electronic device, and the DCM may adjust adaptively the updating frequency of the second image based on an average value of the plurality of temperature data.

In accordance with one or more other embodiments, a method for processing images in an electronic device which includes a graphic processing unit (GPU) includes displaying a first image rendered by the GPU on a first window of a display panel; displaying a third image rendered by the GPU on a second window of the display panel; collecting, by a display control module (DCM), at least one temperature data of at least one measurement point of the electronic device; and individually adjusting, by the DCM, updating frequencies of a second image and a fourth image based on the collected at least one temperature data, wherein the second image is to be displayed on the first window subsequent to the first image and wherein the fourth image is to be displayed on the second window subsequent to the third image.

The method may include individually adjusting the updating frequencies of the second image and the fourth image by delaying one of a first updating operation on the second image or a second updating operation on the fourth image, and delaying, by the DCM, one of the first updating operation on the second image or the second updating operation on the fourth image based on a first work cycle on the first window and a second work cycle on the second window and the at least one temperature data.

In accordance with one or more other embodiments, a method for controlling a display includes displaying a first image; determining a temperature of the display or a host device; and adjusting an updating frequency of a second image based on the temperature, wherein the second image is to be displayed on the display panel subsequent to the first image and wherein adjusting the updating frequency includes reducing the updating frequency of the second image when the temperature is above a predetermined value, reducing the updating frequency to reduce the temperature of the host device.

Adjusting the updating frequency may include adjusting a consumption speed of the second image rendered in an internal buffer to the display. The first image may be rendered by a graphic processing unit. The temperature may be a temperature of the display. The temperature may be a temperature of the host device.

### BRIEF DESCRIPTION OF THE DRAWINGS

Features will become apparent to those of skill in the art by describing in detail exemplary embodiments with reference to the attached drawings in which:

FIG. 1 illustrates an embodiment of an electronic device;

FIG. 2 illustrates a cross-sectional view of the electronic device;

FIG. 3 illustrates an example of performing control based on temperature;

FIG. 4 illustrates an enlarged region in FIG. 3;

FIG. 5 illustrates an embodiment of an application processor;

FIG. 6 illustrates an embodiment of a display control module;

FIG. 7 illustrates an embodiment of a display controller;

FIG. 8 illustrates another embodiment of a display controller;

FIG. 9 illustrates an example of the operation of the display control module;

FIG. 10 illustrates an embodiment of a method for processing images;

FIG. 11 illustrates a diagram for explaining the method;

FIG. 12 illustrates an embodiment of a method for processing images;

FIG. 13 illustrates an example for adaptively adjusting updating frequency;

FIG. 14 illustrates another example for adaptively adjusting updating frequency;

FIG. 15 illustrates another embodiment of a method for processing images;

FIG. 16 illustrates an embodiment of an electronic device;

FIG. 17 illustrates an embodiment of a mobile device; and

FIG. 18 illustrates an example of an interface for an electronic device.

### DETAILED DESCRIPTION

Example embodiments are described more fully hereinafter with reference to the drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

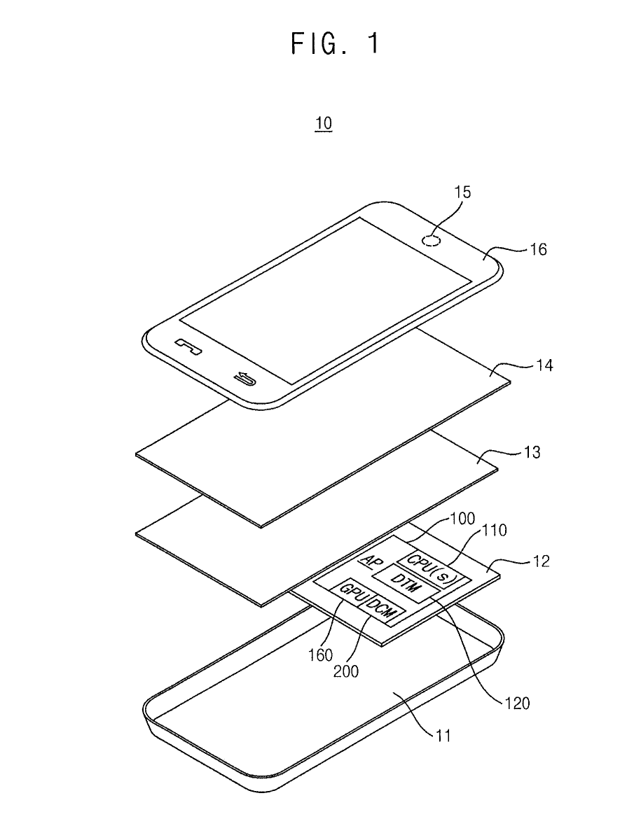

FIG. 1 illustrates an embodiment of an electronic device 10 which includes a housing 11, a printed circuit board 12, a display panel 13, a touch screen or panel 14, an image sensor 15, and a window member 16. The electronic device 10 may be, for example, a smartphone or another type of electronic devices, including but not limited to a television, a navigation system, a computer monitor, a game machine, a tablet PC, or another mobile device.

The housing 11 includes the printed circuit board 12, the display panel 13, and the touch screen or panel 14. In FIG. 1, there is illustrated an example in which the housing 11 is formed of one member. However, the housing 11 may be formed of, for example, at least two members. The housing 11 may further include, for example, a power supply such as a battery of a type which corresponds to the requirements of the display panel 13.

At least one active element and/or at least one passive element may be mounted on the printed circuit board 12 to drive the electronic device 10. The printed circuit board 12 may include, for example, a semiconductor chip or a semiconductor package including the semiconductor chip. The semiconductor chip may be, for example, an application processor (hereinafter, referred to as AP) 100 to process multimedia data (e.g., picture or image) using an application program, a graphic processing unit (GPU), a logic chip, or a memory chip. The application program may be stored, for example, in a memory device of the printed circuit board 12 or the AP 100.

The AP 100 includes at least one CPU 110, a dynamic temperature management module (hereinafter, referred to as a DTM module) 120, a GPU 160 and a display control module (hereinafter, referred to as a DCM) 200. The DTM module 120 manages the temperature or heat generation of a target part of the electronic device 10 based on the temperature of a measurement point of the electronic device 10. The measurement point may be, for example, any point of within or on the surface of the AP 100. The target unit part may be, for example, the housing 11, the display panel 13, the touch screen 14, the window member 16, or an internal specific part.

The DTM module 120 may be implemented so that the surface temperature of the target part does not exceed a predetermined value. The DTM module 120 may be implemented by hardware, software (e.g., firmware), or a combination thereof. When the DTM module 120 is implemented at least partially by firmware, it is possible to update the DTM module 120 anytime.

In example embodiments, the measurement point may be, for example, a point within or on the surface of the AP 100. A temperature sensor may be included within the AP 100 or mounted on a semiconductor package including the AP 100. The DTM module 120 may include a temperature management table indicating relationship between a temperature of the measurement point and a surface temperature of the target part. The temperature management table may be set or provided, for example, by the manufacturer of the electronic device 10.

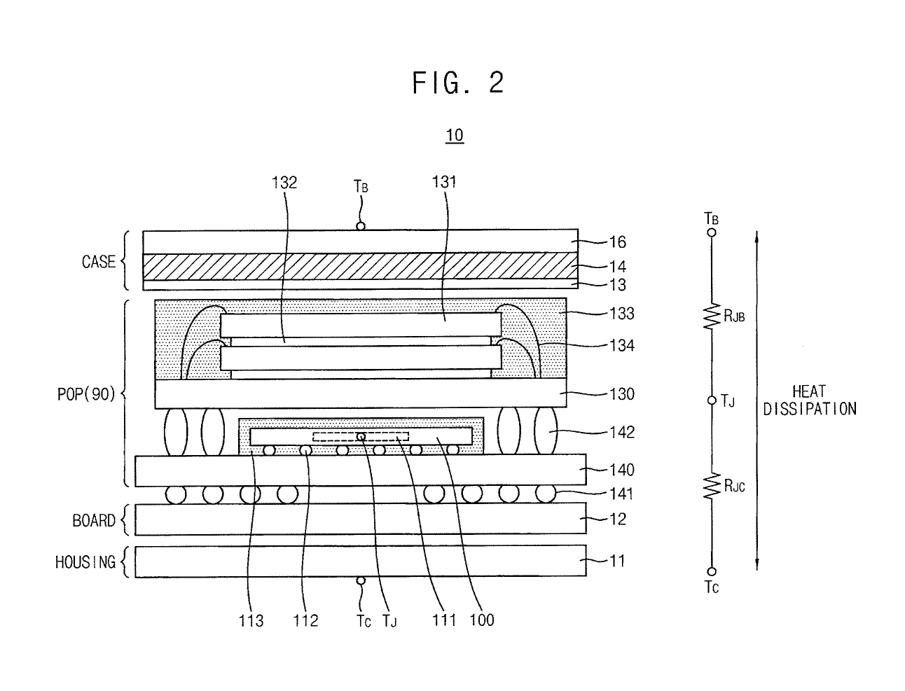

In accordance with one embodiment, the relationship between the temperature of the measurement point and the surface temperature of the target part is computed using thermal transfer modeling. An example is described with reference to FIG. 2.

The GPU 160 renders an image to be displayed on the display panel 13.

The DCM 200 receives temperature data indicating a temperature of the measurement point of the AP 100. The DCM 200 adaptively adjusts the updating frequency of images displayed on the display panel 13 based on the received temperature data. The DCM 200 may decrease the updating frequency of the images displayed on the display panel 13, based on the received temperature data, by delaying updating of a next frame to be displayed on the display panel 13 subsequent to a current frame.

The display panel 13 displays images, still or moving. The display panel 13 may be any one of a variety of display panels, e.g., an organic light emitting display panel. a liquid crystal display panel, a plasma display panel, an electrophoretic display panel, or an electro-wetting display panel.

The touch panel 14 computes coordinate information of a point touched by an input (e.g., stylus or finger) on the display panel 13. The touch panel 14 may be, for example, a resistive touch panel or a capacitive touch panel. The resistive touch panel may be, for example, an analog resistive touch panel having two resistive films spaced apart from each other or a digital resistive touch panel having first resistive patterns and second resistive patterns spaced apart from the first resistive patterns. The resistive touch panel may detect a voltage output when the two resistive films are touched by an external pressure or when the first and second resistive patterns are touched by an external pressure, and may compute coordinate information of the touched point based on the detection result.

The capacitive touch panel may include, for example, first sensing patterns isolated from second sensing patterns. The second sensing patterns may intersect the first sensing patterns. The capacitive touch panel detects a variation in capacitance generated by the first and second sensing patterns when an input contacts the capacitive touch panel, and computes coordinate information of the contact point based on the variation in capacitance.

The image sensor 15 senses images. The image sensor 15 may be, for example, a CMOS image sensor. In FIG. 1, the image sensor 15 is located within the window member 16. The image sensor 15 may be at a different location in another embodiment.

The window member 16 may be, for example, on the touch panel 14 and may be combined with the housing 11 to form an external surface of the electronic device 10. In this case, the touch panel 14 may be combined with the window member 16. The window member 16 may include, for example, a display region to display images generated from the display panel 13 and a non-display region adjacent to at least a part of the display region.

The electronic device 10 may include a number of additional features, e.g., a wireless communication unit, a nonvolatile/volatile memory, a microphone, a speaker, an audio processing unit, and so on. The electronic device 10 manages the temperature of the target part or heat generation using the temperature of the measurement point and the temperature management table.

FIG. 2 illustrates a cross-sectional view of the electronic device 10. Referring to FIG. 2, the electronic device 10 includes the housing 11, the printed circuit board 12, an upper case, and a semiconductor package 90. The semiconductor package 90 include, for example, a package-on-package (POP) structure. The upper case includes, for example, the display panel 13, the touch screen 14, and the window member 16.

The semiconductor package 90 includes the AP 100, a substrate 140 (first package substrate) on which the AP 100 is disposed, and a plurality of memory chips 131 mounted on a second package substrate 130. The semiconductor package 90 may further include a heat sinking plane for effective radiation of heat.

The AP 100 may be mounted, for example, on a top surface of the first package substrate 140 in a face-down or face-up orientation. The AP 100 is electrically connected to the first package substrate 140 through bumps 112 and sealed by a first molding film 113. One or more memory chips 131 may be interconnected (for example, by adhesive films 132) and attached to a top surface of the second package substrate 130. The memory chips 131 may be, for example, isolated by the adhesive films 132. The memory chips 131 may be electrically connected to the second package substrate 130 through, for example, bonding wires 134 and may be sealed by a second molding film 133. The first and second package substrates 140 and 130 may be electrically connected through, for example, solder balls 142. One or more external terminals 141 (first external terminals) may contact and/or be attached to a bottom surface of the first package substrate 140. The external terminals 141 connect the semiconductor package 90 to the printed circuit board 12.

Other packages may be used instead of a PoP structure. Examples include Package-In-Package (PIP), System-In-Package (SIP), Chip-On-Board (COB), Board-On-Chip (BOC), and a Multichip Package (MCP). Alternatively, a semiconductor chip (e.g., a memory chip or a logic chip) or the semiconductor package 90 may be replaced with a central processing unit (CPU).

The semiconductor package 90 includes a temperature sensor 111 for sensing the temperature of the electronic device 100. The temperature sensor 111 may be, for example, embedded in the AP 100 or in the first package substrate 140. In the semiconductor package 100, the AP 100 may produce heat. Thus, in one embodiment, the temperature of the AP 100 may indicate the temperature of the semiconductor package 90, e.g., the temperature of the AP 100 and a temperature of the semiconductor package 90 may be considered the same for at least some applications.

When the measurement point of the temperature sensed by the temperature sensor 111 is different from the target part (which serves as an object of temperature control), the relationship between a temperature of the measurement point and the temperature of the target part may be computed, for example, by thermal transfer modeling. In one embodiment, it may be assumed that the measurement point is any point within or on the surface of the AP 100. The target part may be, for example, any point of the display panel 13, the touch screen 14, or the window member 16.

The AP 100 may serve as a heating source for determining the temperature of the target part. The heat radiated from the AP 100 may be transferred to the target part through the semiconductor package 90. As thermal transfer modeling is established between the AP 100 and the target part, the temperature of the target part may be determined by a temperature of the AP 100.

For example, Equation 1 shows the relationship between the temperature of the AP 100 and the temperature of the target part.

T_{J}=T_{B}+R_{JB}×P_{JB} (1)

where T_{J} indicates the temperature of the measurement point (e.g., a point within or on a surface of the AP 100), T_{B} indicates the temperature of the target part (e.g., a point of a case of the device), RIB indicates thermal resistance (W) between the measurement point and the target part, and P_{JB} indicates heat (° C./W) emitted from the measurement point to the target part.

When the target part is a housing, Equation 2 may show the relationship between the temperature of the AP 100 and the temperature of the target part.

T=T_{C}+R_{JC}×P_{JC} (2)

where T_{J} indicates the temperature of the measurement point (e.g., a point within or on a surface of the AP 10), T_{C} indicates the temperature of the target part (e.g., a point of the housing), R_{JC} indicates thermal resistance (W) between the measurement point and the target part, and P_{JC} indicates heat (° C./W) emitted from the measurement point to the target part.

In Equations 1 and 2, the thermal resistance R_{JB} and R_{JC} may be experimentally obtained, for example, by performing a thermal transfer test on the electronic device 10. Also, in Equations 1 and 2, the heat R_{JB} and R_{JC} may vary according to the operating frequency of the AP 100 and a program executed by the AP 100. Like thermal resistance, however, each of the heat R_{JB} and R_{JC} may be experimentally obtained by performing, for example, a thermal transfer test on an operating frequency and an execution program. Any one of a variety of known techniques may be used to experimentally determine the thermal resistance R_{JB} and R_{JC} and the heat P_{JB} and P_{JC}.

From Equations 1 and 2, it is possible to measure temperatures of a variety of positions (e.g., a position at which the temperature sensor 111 is located) through the thermal transfer modeling method. Thus, a reference temperature may be established for a variety of positions of the electronic device 10. For example, the temperature of the window member 16 may be obtained by measuring the temperature of the AP 100.

FIG. 3 illustrates an example of how the temperature of a measurement point may be controlled according to one embodiment. In FIG. 3. curve I is a temperature curve of a measurement point where control is not performed and curve II is a temperature curve of a measurement point where control is performed. The measurement point may be a point within or on a surface of an AP 100 (refer to FIG. 2). In the case of curve I, the AP 100 continues to operate according to the same clock frequency. Also, the heating value of the AP 100 may be accumulated, not decreased. Thus, the temperature of the measuring point continues to increase (see the dotted curve).

However, in the case of curve II, when the temperature of the measuring point reaches a target temperature (hereinafter, referred to as a high target temperature), the electronic device 10 (refer to FIG. 2) performs a control operation to reduce the clock frequency. This may be performed to reduce the heating value of the AP 100. When the clock frequency of the AP 100 decreases, the heating value of the AP 100 may reduce.

In this case, the temperature of the measurement point may be limited to below a constant level. When the clock frequency of the AP 100 decreases, the data processing speed of the AP 100 may also be lowered. Thus, if the temperature of the measurement point becomes lower than another target temperature (hereinafter, referred to as a low target temperature) according to a reduction in the clock frequency of the AP 100, the electronic device 10 may control the clock frequency of the AP 100 to increase.

As a result, the electronic device 10 may maintain the data processing speed of the AP 100 appropriately. With the above description, the temperature of the measurement point may be controlled to be maintained between the high target temperature and the low target temperature (curve II).

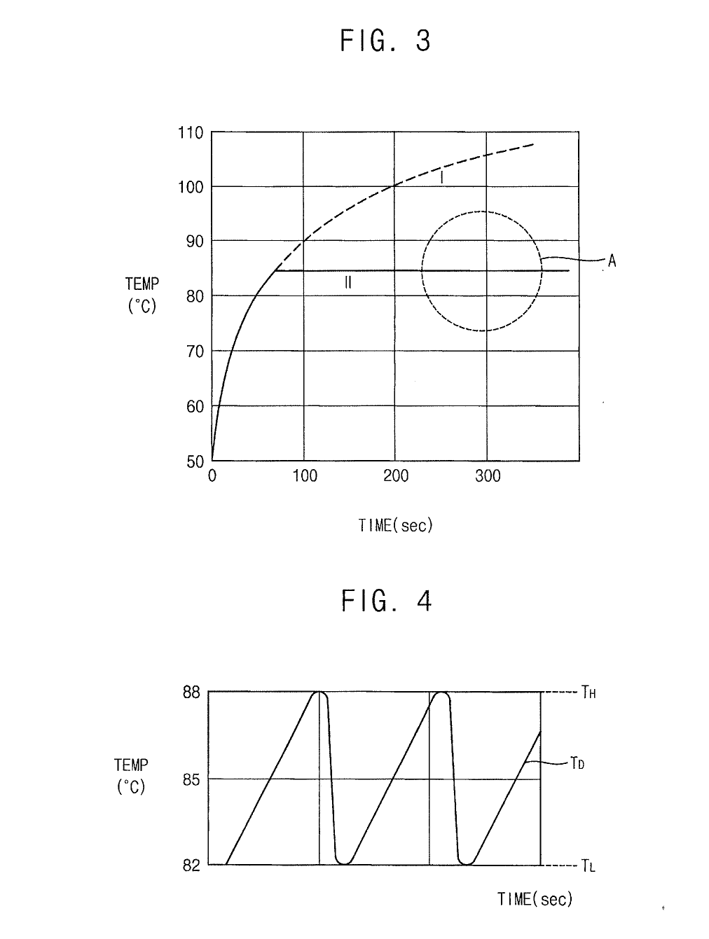

FIG. 4 illustrates an example of region A in FIG. 3. Referring to FIG. 4, region A may indicate a period in which the temperature of a measurement point is maintained between a high target temperature and a low target temperature. Hereinafter, this period may be referred to as a throttling period.

When the temperature of the measurement point reaches a high target temperature T_{H}, the electronic device 10 (refer to FIG. 2) may, for example, lower the clock frequency of an AP 100 (refer to FIG. 2). Simultaneously, the DCM 200 decreases updating frequency of the rendered images displayed on the display panel 13. The heating value of the AP 100 may be reduced based on the decrease in clock frequency, in order to reduce the temperature of the measuring point.

When a temperature of the measuring point reaches a low target temperature T_{L}, the electronic device 10 may, for example, increase the clock frequency of the AP 100. Simultaneously, the DCM 200 increases updating frequency of the rendered images displayed on the display panel 13. In this case, the heating value of the AP 100 may increase, in order to increase the temperature of the measuring point.

When the temperature of the measuring point again reaches the high target temperature T_{H}, the electronic device 10 may, for example, again lower the clock frequency of the AP 100. Thus, during the throttling period, the temperature curve of the measurement point may oscillate between the high target temperature T_{H} and the low target temperature T_{L}.

Thus, in accordance with the above, the temperature of the measuring point may be stably maintained, for example, by changing the clock frequency of the AP 100 based on a comparison of the temperature of the measuring point and the target temperature (e.g., the high target temperature and the low target temperature). In addition, the DCM 200 decreases updating frequency of the rendered images when temperature of the measuring point increases, and increases updating frequency of the rendered images when temperature of the measuring point decreases. Thus, power consumption of the electronic device 10 may be reduced.

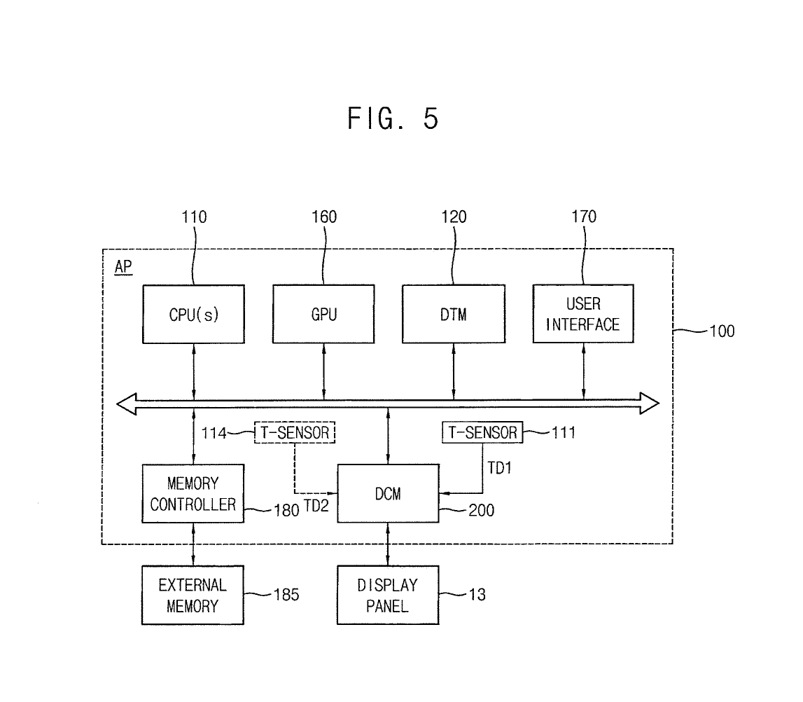

FIG. 5 illustrates an example of the application processor (AP) in the electronic device of FIG. 1. Referring to FIG. 5, the AP 100 includes at least one CPU 100, the DTM module 120, the GPU 160, a user interface 170, a memory controller 180 and at least one temperature sensors 111 and 114. The CPU 110 controls overall operations of the AP 100 and may be implemented, for example, by a multi-core processor.

The GPU 160 renders input images and provides the rendered input images to the DCM 200. The DTM module 120 adaptively manages the temperature of the target part based on a temperature of the measurement point as described above.

The user interface 170 transmits data to a communication network and/or receives data from the communication network. The user interface 170 may be a wired or wireless interface and may include an antenna or wired/wireless transceiver. The user interface 170 may receive an external input and/or an input from a user.

The memory controller 180 is connected and controls the external memory device 185. The external memory device 185 stores image data.

The DCM 200 is coupled to the display panel 13 and controls the display panel 13, so that images rendered by the GPU 160, images stored in the external memory device 185, and images input through the user interface 170 may be displayed on the display panel 13. In addition, the DCM 200 may receive at least one temperature data TD1 and TD2 from the at least one temperature sensors 111 and 114, and may adaptively adjust the updating frequency of the rendered images displayed on the display panel 13 based on the at least one temperature data TD1 and TD2. The adjustment may be performed so that the user does not recognize the adjustment made to the updating frequency.

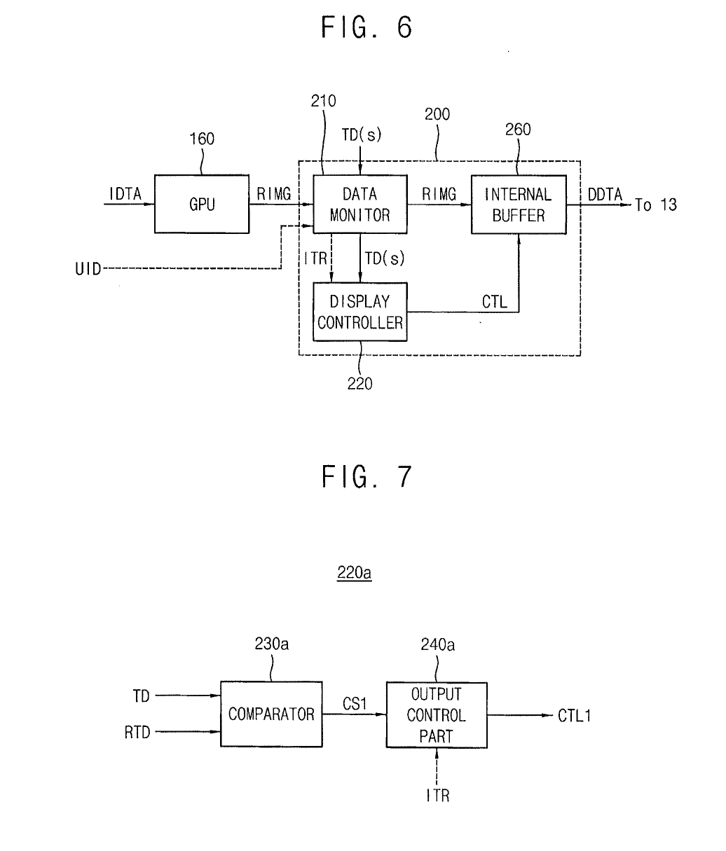

FIG. 6 illustrates an embodiment of the display control module (DCM) 200 in the AP of FIG. 5. Referring to FIG. 6, the DCM (also referred to as an image processing apparatus) 200 includes a data monitor 210, a display controller 220 and an internal buffer 260. The GPU 160 renders an input image data IDTA and provides the rendered image RIMG to the DCM 200.

The data monitor 210 receives the rendered image RIMG from the GPU 160 and receives at least one temperature data TD(s) indicating the temperature of at least one measurement point(s) from the temperature sensors 111 and 114. In addition, the data monitor 210 may receive user image data UID from the user interface 170. The data monitor 210 may provide the rendered image RIMG to the internal buffer 260 and may provide the at least one temperature data TD(s) to the display controller 220. In addition, when the data monitor 210 receives the user image data UID, the data monitor 210 may provide the display controller 220 with an interrupt signal ITR indicating that the user image data UID is received.

The display controller 220 adaptively adjusts the updating frequency of images displayed on the display panel 13 based on the at least one temperature data TD(s). The display controller 220 may receive the at least one temperature data TD(s), compare the at least one temperature data TD(s) with at least one reference data, and increase or decrease the updating frequency of images displayed on the display panel 13 according to the comparison result.

For example, the display controller 220 may decrease the updating frequency of the images when the at least one temperature data is equal to or greater than the at least one reference data. The display controller 220 may increase the updating frequency of the images when the at least one temperature data is smaller than the at least one reference data.

The display controller 220 may increase or decrease the updating frequency of images displayed on the display panel 13, for example, by adjusting the consumption speed of the rendered image RIMG from the internal buffer 260 to the display panel 13. The display controller 220 may apply a control signal CTL to the internal buffer 260 to adjust the consumption speed of the rendered image RIMG from the internal buffer 260 to the display panel 13.

When the display controller 220 receives the interrupt signal ITR from the data monitor 210, the display controller 220 stops adjusting the updating frequency and recovers the updating frequency, such that the rendered image RIMG is displayed on the display panel 13 with unadjusted frequency (original frequency).

The internal buffer 360 may adjust the speed of the rendered image RIMG, being provided to the display panel 13 as display data DDTA, in response to the control signal CTL. The internal buffer 260 may have a storage capacity greater than a size of the display data DDTA.

FIG. 7 illustrates an embodiment of the display controller 220a in FIG. 6 which includes a comparator 230a and an output control part 240a. The comparator 230a receives the temperature data TD and the reference data RTD, compares the temperature data TD and the reference data RTD, and provides the output control part 240a with a comparison signal CS1 indicating the comparison result. The output control part 240a may provide the internal buffer 260 with a control signal CTL1 that adjusts the updating frequency of the display data DDTA displayed on the display panel 13 according to a logic level of the comparison signal CS1. The reference data RTD may be stored in a register and may be updated by a user. The output control part 240a may receive the interrupt signal ITR.

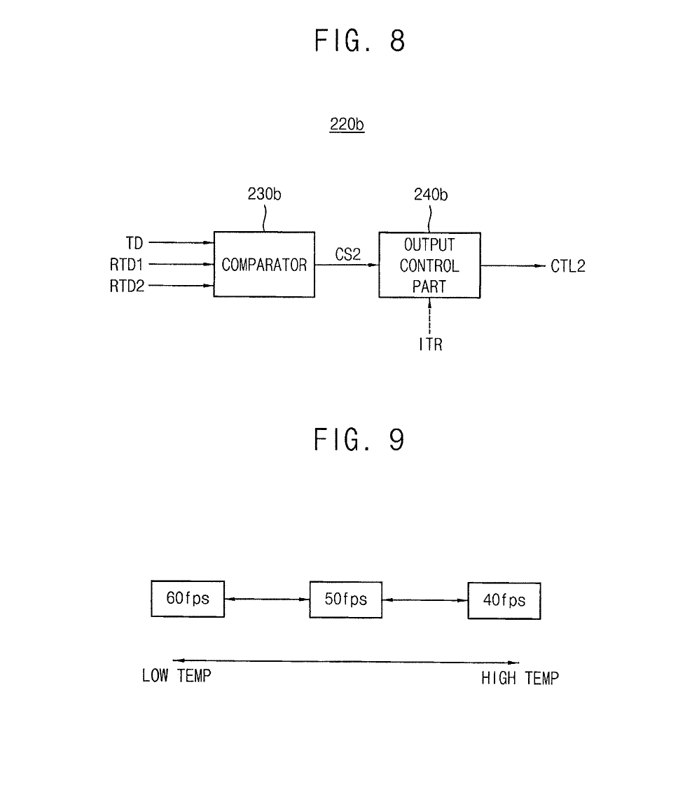

FIG. 8 illustrates another embodiment of the display controller 220b which includes a comparator 230b and an output control part 240b. The comparator 230b receives the temperature data TD, a first reference data RTD1, and a second reference data RTD2, compares the temperature data TD with the first reference data RTD1 and the second reference data RTD2, and provides the output control part 240b with a comparison signal CSs indicating the comparison result. The output control part 240b may provide the internal buffer 260 with a control signal CTL2 that adjusts the updating frequency of the display data DDTA displayed on the display panel 13 according to a logic level of the comparison signal CS2. The reference data RTD may be stored in a register and may be updated by a user. The output control part 240a may receive the interrupt signal ITR. The output control part 240b may receive the interrupt signal ITR.

For example, when the temperature data TD is smaller than the first reference data RTD1, the comparator 230b provides the output control part 240b with the comparison signal CS2 with ‘00’. The output control part 240b may decrease or maintain the updating frequency of the display data DDTA displayed on the display panel 13 to output the control signal CTL2 to the internal buffer 260, so that the GPU 160 renders the input image data IDTA with a first frequency. The first frequency may correspond to 60 frame per second (fps).

When the temperature data TD is equal to or greater than the first reference data RTD1 and is smaller than the second reference data RTD2, the comparator 230b provides the output control part 240b with the comparison signal CS2 with ‘01’. The output control part 240b may adjust the updating frequency of the display data DDTA displayed on the display panel 13 to output the control signal CTL2 to the internal buffer 260, so that the GPU 160 renders the input image data IDTA with a second frequency smaller than the first frequency. The second frequency may correspond to 50 fps.

When the temperature data TD is equal to or greater than the second reference data RTD2, the comparator 230b provides the output control part 240b with the comparison signal CS2 with ‘10’. The output control part 240b may adjust the updating frequency of the display data DDTA displayed on the display panel 13 to output the control signal CTL2 to the internal buffer 260, so that the GPU 160 renders the input image data IDTA with a third frequency smaller than the second frequency. The third frequency may correspond to 40 fps.

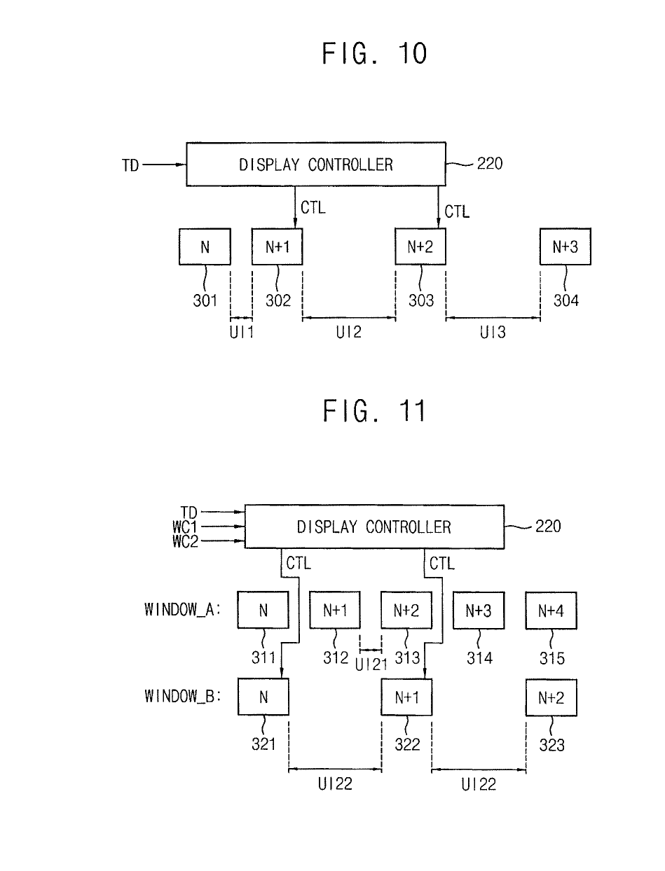

FIG. 9 illustrates an example of the operation of the DCM 200. Referring to FIGS. 6 to 9, the DCM 200 decreases the updating frequency of the display data DDTA displayed on the display panel 13 as the temperature of the measurement point becomes higher, and increases the updating frequency of the display data DDTA displayed on the display panel 13 as the temperature of the measurement point becomes lower.

FIG. 10 is a diagram illustrating one embodiment of a method for processing images. Referring to FIG. 10, in this method, the display controller 220 of the DCM 200 receives an N-th image 301 rendered by the GPU 160, stores the N-th image 301 in the internal buffer 260, and outputs the N-th image 301 stored in the internal buffer 260 to the display panel 13. When the internal buffer 260 is consumed, the display controller 220 receives an (N+1)-th image 302 rendered by the GPU 160, stores the (N+1)-th image 302 in the internal buffer 260, and outputs the (N+1)-th image 302 stored in the internal buffer 260 to the display panel 13. The time difference between the N-th image 301 and the (N+1)-th image (a first image) 302 may correspond to a first updating interval UI1.

When the temperature data TD is greater than the reference data RTD, the display controller 220 outputs the control signal CTL to the internal buffer 260 to adjust an updating frequency of an (N+2)-th image (a second image) 303, so that the (N+2)-th image 302 subsequent to the (N+1)-th image 302 has a second updating interval UI2 with respect to the (N+1)-th image 302. The second updating interval UI2 may be greater than the first updating interval UI1. When the temperature data TD is greater than the reference data RTD. the display controller 220 outputs the control signal CTL to the internal buffer 260 to adjust an updating frequency of an (N+3)-th image (a third image) 304, so that the (N+3)-th image 304 subsequent to the (N+2)-th image 303 has a third updating interval UI2 with respect to the (N+2)-th image 303. The third updating interval UI3 may be greater than the first updating interval UI1.

When the display controller 220 controls the internal buffer 260 so that each of the images 301˜304 is displayed on the display panel 13 with the first updating interval UI1, the GPU 160 renders the input image data IDTA with a first frequency (for example, 60 fps). When the display controller 220 controls the internal buffer 260 so that at least some of the images 301˜304 is displayed on the display panel 13 with the second updating interval UI2 or the third updating interval UI3, the GPU 160 renders the input image data IDTA with an adjusted frequency smaller than the first frequency.

FIG. 11 is a diagram illustrating another embodiment of a method for processing images. In FIG. 11, the method is individually applied to each of two or more graphic applications when two or more graphic applications are executed on the display panel 13. For convenience of explanation, the graphic applications that are simultaneously executed are referred to as a first window WINDOW_A and a second window WINDOW_B.

Referring to FIG. 11, the display controller 220 may individually adjust respective updating frequencies of images of the first window WINDOW_A and the second window WINDOW_B based on the temperature data TD, a first work cycle WC1 on the first window WINDOW_A, and a second work cycle WC2 on the second window WINDOW_B. For the first window WINDOW_A, the display controller 220 may control the internal buffer 260 so that each of images 311-315 in the first window WINDOW_A is displayed on the display panel 13 with a first updating interval UI21. For the second window WINDOW_B, the display controller 220 may apply the control signal CTL to the internal buffer 260 to control the internal buffer 260 so that each of images 321˜323 in the second window WINDOW_B is displayed on the display panel 13 with a second updating interval UI22.

For the first window WINDOW_A, the display controller 220 may control the internal buffer 260 so that the first image 311 and the second image 312 are displayed on the display panel 13 with the first updating interval UI21. While the first image 311 and the second image 312 are consecutively displayed on the display panel 13 with the first updating interval UI21, the display controller 220 controls the internal buffer 260 such that the third image 321 and the fourth image 322 are displayed on the display panel 13 with the second updating interval UI22 for the second window WINDOW_B. The second updating interval UI22 may be greater than the first updating interval UI21. The display controller 220 may control the internal buffer 260, so that the third image 321 and the fourth image 322 are displayed on the display panel 13 with the second updating interval UI22, by delaying updating operation on the fourth image 322.

FIG. 12 illustrates operations included in one embodiment of a method for processing images in an electronic device including a graphic processing unit (GPU). This method will be described with reference to FIGS. 1 and 5 to 12.

Referring to FIGS. 1 and 5 to 12, the DCM 200 displays a first image 302 rendered by the GPU 160 on the display panel 13 (S110). The DCM 200 collects, from the temperature sensor 111, at least one temperature data TD of at least one measurement point of the electronic device (S130). The DCM 200 adaptively adjusts updating frequency of a second image 303 to be displayed on the display panel 13 based on the at least one temperature data TD (S150).

The DCM 200 increases or decreases the updating frequency of the second image 303 based on the at least one temperature data TD. When the data monitor 210 receives an external input from the user interface 170 while the DCM 200 is adjusting the updating frequency of the second image 303, the data monitor 210 applies an interrupt signal ITR to the display controller 220. The display controller 220 adjusts the consumption speed of the internal buffer 260 in response to the interrupt signal ITR, so that the GPU 160 renders the external input with an unadjusted frequency.

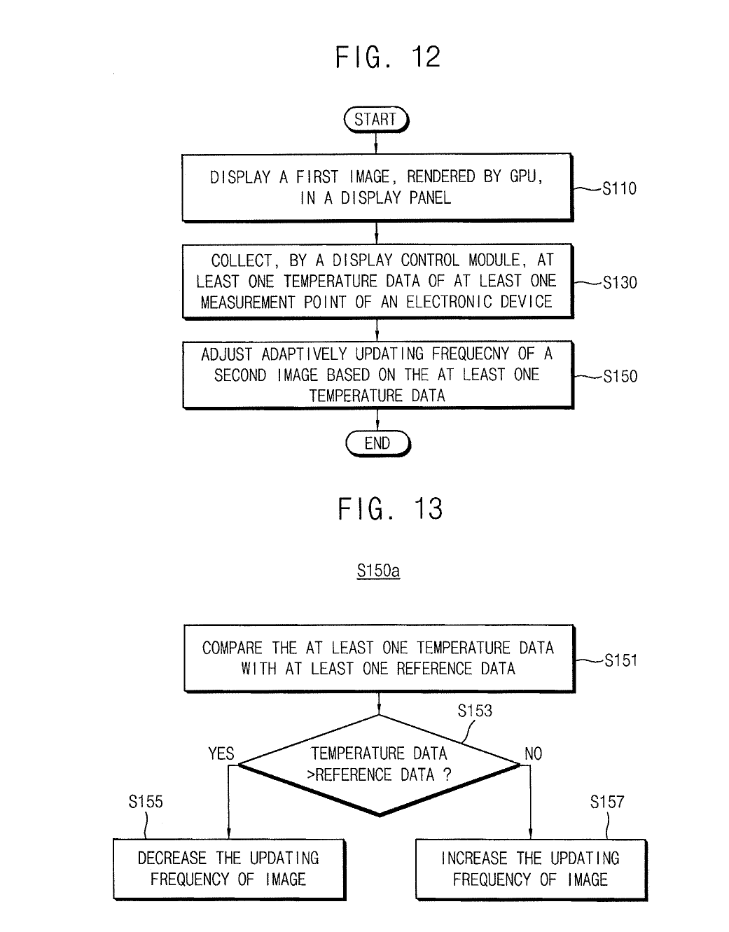

FIG. 13 illustrates an example of an operation for adaptively adjusting the updating frequency of the second image in FIG. 12. Referring to FIGS. 1 and 5 to 13, in order to adaptively adjust the updating frequency of the second image 303 (S150a), the DCM 200 compares the at least one temperature data TD with the reference data RTD (S151) and determines whether the at least one temperature data ID is greater than the reference data RTD as in FIG. 7 (S153).

When the at least one temperature data TD is greater than the reference data RTD (YES in S153), the display controller 220a decreases the updating frequency of the second image 303. This may be accomplished by delaying updating operation on the second image 303 in the internal buffer 260 using the control signal CTL1 (S155). When the at least one temperature data TD is not greater than the reference data RTD (NO in S153), the display controller 220a increases the updating frequency of the second image 303 by accelerating updating operation on the second image 303 in the internal buffer 260 using the control signal CTL1 (S157).

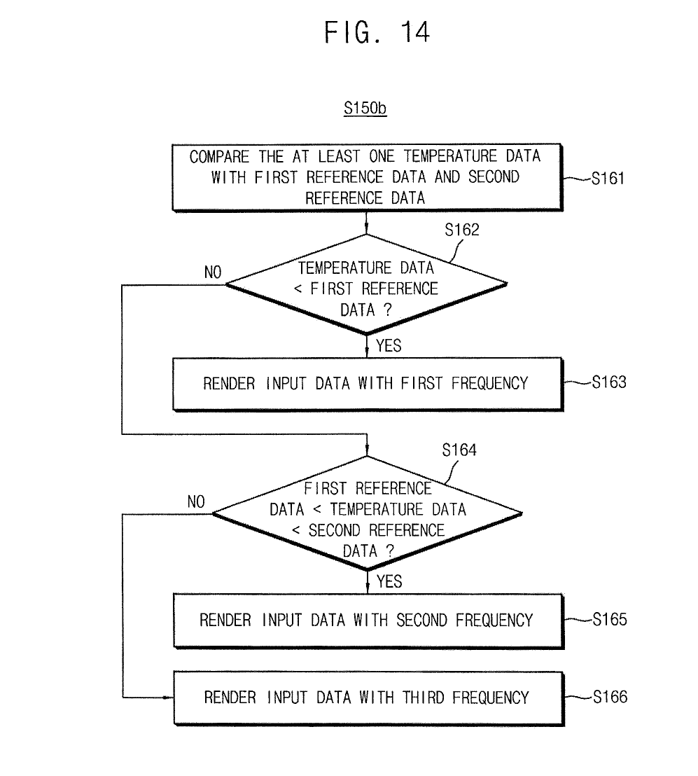

FIG. 14 illustrates another operation for adaptively adjusting the updating frequency of the second image in FIG. 12. Referring to FIGS. 1, 5 to 12 and 14, in order to adaptively adjust the updating frequency of the second image 303 (S150b), the DCM 200 compares the at least one temperature data TD with the first reference data RTD1 and the second reference data RTD2 (S161), and determines to which range the at least one temperature data TD belongs as in FIG. 6 (S162 and S164).

When the at least one temperature data TD is smaller than the first reference data RTD1 (YES in S162), the display controller 200 adjusts the updating frequency of the second image, so that the GPU 160 renders the input image data IDTA with a first frequency per unit time as in FIG. 9 (S163).

When the at least one temperature data TD is not smaller than the first reference data RTD1 (NO in S162) and is smaller than the second reference data (YES in S164), the display controller 200 adjusts the updating frequency of the second image so that the GPU 160 renders the input image data IDTA with a second frequency smaller than the first frequency per unit time as in FIG. 9 (S165).

When the at least one temperature data TD is not smaller than the second reference data RTD2 (NO in S164), the display controller 200 adjusts the updating frequency of the second image so that the GPU 160 renders the input image data IDTA with a third frequency smaller than the second frequency per unit time as in FIG. 9 (S166).

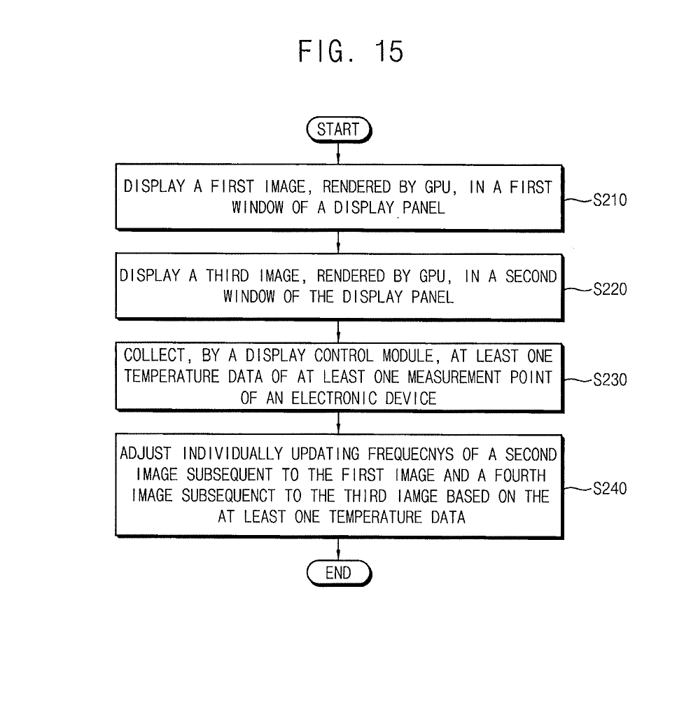

FIG. 15 illustrates another embodiment of a method for processing images in an electronic device including a GPU. Referring to FIGS. 1, 5 to 11, and 15, the DCM 200 displays a first image 311 rendered by the GPU 160 on a first window WINDOW_A in the display panel 13 (S210). The DCM 200 displays a third image 321 rendered by the GPU 160 on a second window WINDOW_B in the display panel 13 (S220). The DCM 200 collects, from the temperature sensor 111, at least one temperature data TD of at least one measurement point of the electronic device (S230). The DCM 200 individually adjusts updating frequencies of a second image 312 and a fourth image 322 based on the collected at least one temperature data TD (S240). The second image 312 is to be displayed on the first window WINDOW_A subsequent to the first image 311 and the fourth image 322 is to be displayed on the second window WINDOW_B subsequent to the third image 321.

As described with reference to FIG. 11, the display controller 220 individually adjusts respective updating frequencies of images of the first window WINDOW_A and the second window WINDOW_B based on the temperature data TD, the first work cycle WC1 on the first window WINDOW_A, and the second work cycle WC2 on the second window WINDOW_B. For the first window WINDOW_A, the display controller 220 controls the internal buffer 260 so that each of images 311˜315 in the first window WINDOW_A is displayed on the display panel 13 with a first updating interval UI21. For the second window WINDOW_B, the display controller 220 applies the control signal CTL to the internal buffer 260 to control the internal buffer 260, so that each of images 321˜323 in the second window WINDOW_B is displayed on the display panel 13 with a second updating interval UI22.

In FIGS. 12 to 15, the at least one temperature data TD may be the temperature data TD1 from the temperature sensor 111, the temperature data TD2 from the temperature sensor 114, or may be an average value of temperature data TD1 and TD2.

As described above with reference to FIGS. 1 through 15, the electronic device 10 may reduce heat generation and power consumption while maintaining performance by adjusting updating intervals of the images displayed on the display panel 13. The adjusted updating intervals may adjust updating frequency of the images based on at least one temperature data of at least one measurement point of the electronic device 10.

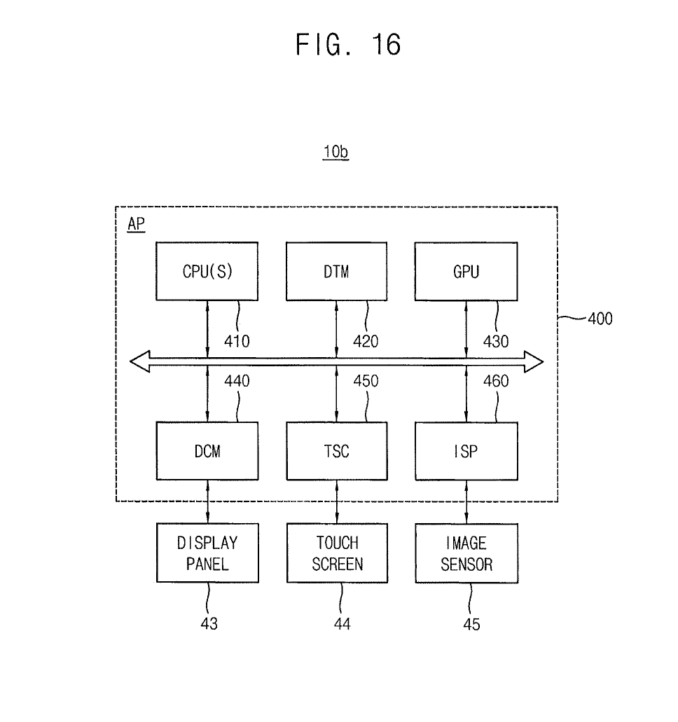

FIG. 16 illustrates an embodiment of an electronic device 10b which includes an AP 400, a display panel 43, a touch screen 44 and an image sensor 45. The AP 400 may include, for example, at least one CPU 410, a DTM module 420, a GPU 430, a DCM 440, a touch screen controller (TSC) 450 and an image signal processor (ISP) 460.

The DTM module 420 manages the temperature or heat generation of a target part of the electronic device 10b as the DTM module 120 in FIG. 5. The TSC 450 is coupled and controls operation of the touch screen 44. The ISP 460 is coupled to the image sensor 45, processes image signals from the image sensor 45, and provides the processed image signals to the DCM 440.

The DCM 440 employs the DCM 200 in FIG. 5. Therefore, the DCM 440 may reduce heat generation and power consumption of the electronic device 10b while maintaining performance, by adjusting updating intervals of the images displayed on the display panel 43, to thereby adjust updating frequency of the images based on at least one temperature data of at least one measurement point of the electronic device 10b.

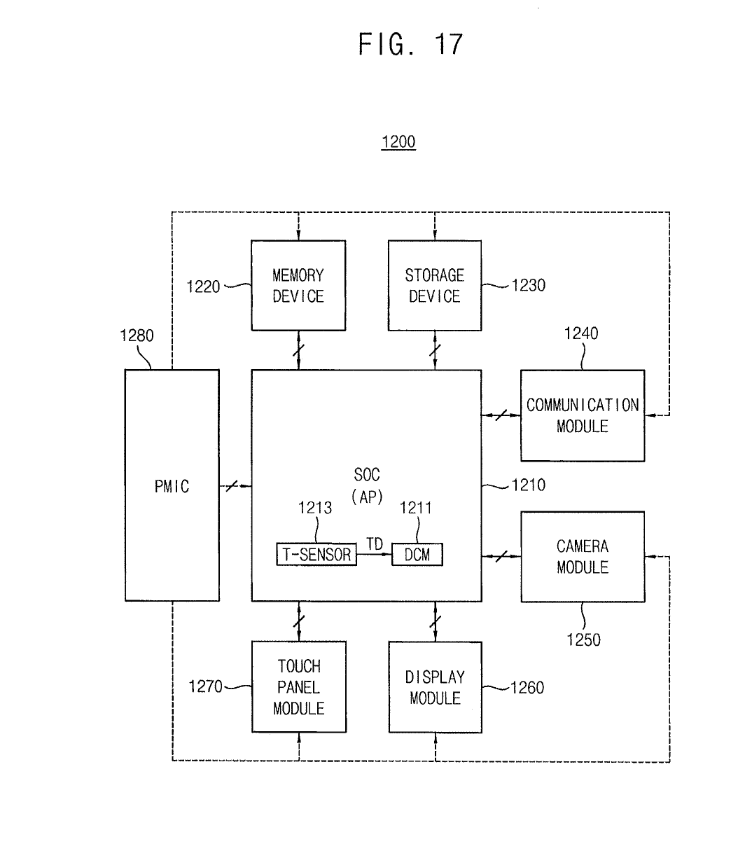

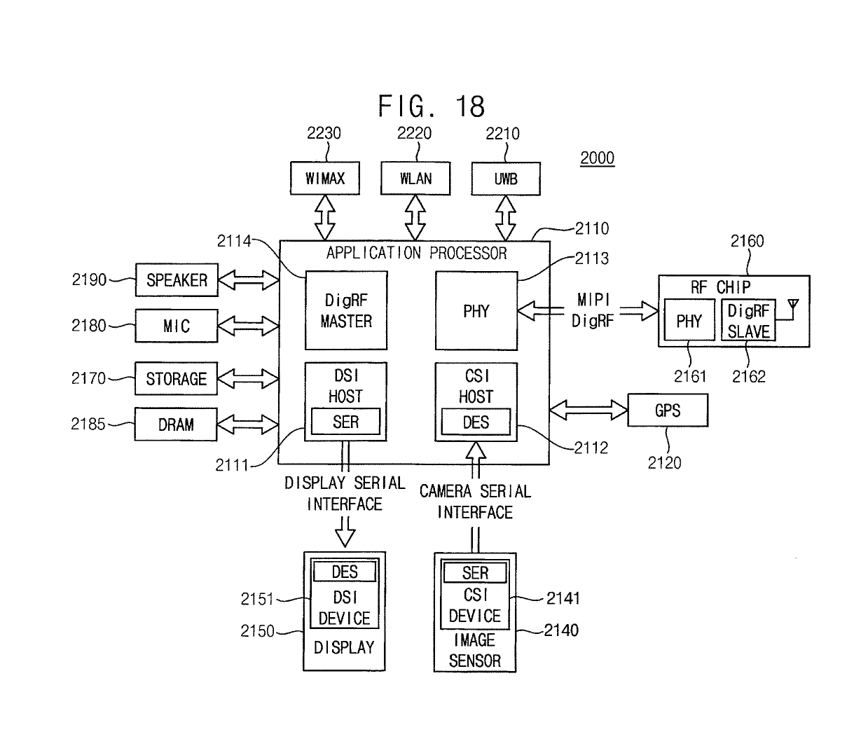

FIG. 17 illustrates an embodiment of a mobile device 1200 which includes a system on-chip 1210, a memory device 1220, a storage device 1230, a plurality of function modules 1240, 1250, 1260, and 1270, and a power management integrated circuit 1280. The power management integrated circuit 1280 may provide an operating voltage to the system on-chip 1210, the memory device 1220, the storage device 1230, and the function modules 1240, 1250, 1260, and 1270, respectively. The mobile device 1200 may be, for example, a smart-phone or a tablet PC, and the system on-chip 1210 may correspond to an application processor (AP).

The AP 1210 may control overall operations of the mobile device 1200. For example, the application processor 1210 may control the memory device 1220, the storage device 1230, and the function modules 1240, 1250, 1260, and 1270. The AP 1210 may monitor an operating state or an operating condition of a central processing unit (CPU) in the AP 1210, and may perform a dynamic voltage and frequency scaling (DVFS) (e.g., increase, decrease, or maintain an operating frequency of the central processing unit) based on the monitored operating condition of the central processing unit. In one embodiment, the DVFS may be performed by hardware or software.

The AP 1210 may include a temperature sensor 1213 and a DCM 1211 as in the AP 100 of FIG. 1. Therefore, the AP 1210 may reduce heat generation and power consumption of the mobile device 1200 while maintaining performance, by adjusting updating intervals of the images displayed on the display panel. to thereby adjust updating frequency of the images based on at least one temperature data of at least one measurement point of the AP 1210.

The memory device 1220 and the storage device 1230 store data for operations of the mobile device 1200. In some example embodiments, the memory device 1220 and the storage device 1230 may be included in the application processor 1210. For example, the memory device 1220 may include a volatile semiconductor memory device such as a dynamic random access memory (DRAM) device, a static random access memory (SRAM) device, a mobile DRAM, etc.

In addition, the storage device 1230 may include a non-volatile semiconductor memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. In some example embodiments, the storage device 1230 may further include a solid state drive (SSD), a hard disk drive (HDD), a CD-ROM, etc. However, kinds of the memory device 1220 and the storage device 1230 are not limited thereto.

The function modules 1240, 1250, 1260, and 1270 may perform various functions of the mobile device 1200. For example, the mobile device 1200 may include a communication module 1240 that performs a communication function (e.g., a code division multiple access (CDMA) module, a long term evolution (LTE) module, a radio frequency (RF) module, an ultra wideband (UWB) module, a wireless local area network (WLAN) module, a worldwide interoperability for microwave access (WIMAX) module, etc.), a camera module 1250 that performs a camera function, a display module 1260 that performs a display function, a touch panel module 1270 that performs a touch-input sensing function, etc.

The display module 1260 may include the above-described DDI and a display panel. Therefore, the display module 1260 includes at least a first TED and a second TED. The first TED processes a first image data to generate a first display data and the second TED processes a second image data to generate a second display data. One of the first TED and the second TED, which operates as a master, controls display timing of the first display data and the second display data such that corresponding image lines of the first and second display data are displayed in synchronization with respect to each other in the display panel.

In some example embodiments, the mobile device 1200 may further include a global positioning system (UPS) module, a microphone (MIC) module, a speaker module, various sensor modules (e.g., a gyroscope sensor, a geomagnetic sensor, an acceleration sensor, a gravity sensor, an illumination sensor, a proximity sensor, a digital compass, etc.). However, kinds of the function modules 1240, 1250, 1260, and 1270 included in the mobile device 1200 are not limited thereto.

The elements illustrated in FIG. 17 may be implemented with various packaging schemes. For example, at least some elements may be implemented using Package on Package (PoP), Ball grid arrays (BGAs). Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), etc.

FIG. 18 illustrates an embodiment of an interface for an electronic device 2000, which, for example, may be a data processing device (for instance, a portable phone, a personal digital assistant, a portable multimedia player, or a smart phone) that uses or supports an MIPI interface, and may include an application processor 2110, an image sensor 2140 and a display 2150.

A CSI host 2112 of the application processor 2110 performs serial communication with a CSI device 2141 of the image sensor 2140 through a camera serial interface (CSI). In one embodiment, the CSI host 2112 may include an optical serializer DES and the CSI device 2141 may include an optical serializer SER. A DSI host 2111 of the application processor 2110 can make serial communication with a DSI device 2151 of the display 2150 through a display serial interface (DSI). In one embodiment, the DSI host 2111 may include an optical serializer SER and the DSI device 2151 may include an optical serializer DES. The application processor 2110 may include a temperature sensor and a DCM as in the AP 100 of FIG. 1. Therefore, the application processor 2110 may reduce heat generation and power consumption of the mobile device 1200 while maintaining performance. by adjusting updating intervals of the images displayed on the display panel, to thereby adjust updating frequency of the images based on at least one temperature data of at least one measurement point of the application processor 2110.

In addition, the electronic device 2000 may further include an RF (radio frequency) chip 2160 which can make communication with the application processor 2110. Data may be transceived between a PHY 2113 of the mobile device 2000 and a PHY 2161 of the RF chip 2160 according to the MIPI (Mobile Industry Processor Interface) DigRF. In addition, the application processor 2110 may further include a DigRF MASTER 2114 to control data transmission according to the MIPI DigRF and the RF chip 2160 may further include a DigRF SLAVE 2162 which is controlled by the DigRF MASTER 2114.

The electronic device 2000 may include a GPS (Global Positioning System) 2120, a storage 2170, a microphone 2180, a DRAM (Dynamic Random Access Memory) 2185 and a speaker 2190. In addition, the mobile device 2000 can perform the communication using a UWB (Ultra WideBand) 2210, a WLAN (Wireless Local Area Network) 2220 and a WIMAX (Worldwide Interoperability for Microwave Access) 2230. The structure and the interface of the mobile device 2000 are illustrative purposes only and example embodiments may not be limited thereto. The present embodiments may be applied to portable electronic devices such as a smart phone or a table PC.

The methods, processes, and/or operations described herein may be performed by code or instructions to be executed by a computer, processor, controller, or other signal processing device. The computer. processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The processing and other control features of the aforementioned embodiments may be implemented in logic which, for example, may include hardware, software, or both. When implemented at least partially in hardware, the processing and other control features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the processing and other control features may include, for example, a memory or other storage device for storing code or instructions to be executed, for example, by a computer, processor, microprocessor, controller, or other signal processing device. The computer, processor, microprocessor, controller. or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A method for processing images in an electronic device which includes a graphics processor (GP), the method comprising:
displaying a first image rendered by the GP on a display panel;
collecting, by a display control module (DCM), at least one temperature data of at least one measurement point of the electronic device; and
adaptively adjusting, by the DCM, an updating frequency of a second image based on the collected at least one temperature data, the second image to be displayed on the display panel subsequent to the first image.

2. The method as claimed in claim 1, wherein adaptively adjusting the updating frequency of the second image includes:
comparing the at least one temperature data with at least one reference data; and
increasing or decreasing, by the DCM, the updating frequency of the second image according to a result of the comparison.

3. The method as claimed in claim 2, further comprising:
delaying, by the DCM, updating the second image to decrease the updating frequency of the second image when the at least one temperature data is substantially equal to or greater than the at least one reference data.

4. The method as claimed in claim 2, further comprising:
stop delaying updating, by the DCM, the second image to decrease the updating frequency of the second image when the at least one temperature data is smaller than the at least one reference data.

5. The method as claimed in claim 2, further comprising:
storing rendered images in an internal buffer in the DCM; and
adjusting, by the DCM, the updating frequency of the second image by adjusting a consumption speed of the rendered second image from the internal buffer to the display panel.

6. The method as claimed in claim 5, further comprising:
decreasing, by the DCM, consumption speed of the rendered second image from the internal buffer to the display panel when the at least one temperature data is substantially equal to or greater than the at least one reference data.

7. The method as claimed in claim 5, further comprising:
increasing, by the DCM, consumption speed of the rendered second image from the internal buffer to the display panel when the at least one temperature data is smaller than the at least one reference data.

8. The method as claimed in claim 2, wherein the at least one reference data includes a first reference data and a second reference data greater than the first reference data.

9. The method as claimed in claim 8, further comprising:
adjusting, by the DCM, the updating frequency of the second image so that the GP renders input image data with a first frequency per unit time when the at least one temperature data is smaller than the first reference data.

10. The method as claimed in claim 9, further comprising:
adjusting, by the DCM, the updating frequency of the second image so that the GP renders the input image data with a second frequency smaller than the first frequency per unit time, when the at least one temperature data is substantially equal to or greater than the first reference data and is smaller than the second reference data.

11. The method as claimed in claim 10, further comprising:
adjusting, by the DCM, the updating frequency of the second image so that the GP renders the input image data with a third frequency smaller than the second frequency per unit time, when the at least one temperature data is substantially equal to or greater than the second reference data.

12. The method as claimed in claim 1, wherein, when the GP receives an external input instead of input image data while the DCM adjusts the updating frequency of the second image such that the GP renders the input image data with an adjusted frequency smaller than a first frequency per unit time, the DCM adjusts the updating frequency of the second image such that the GP renders the external input with the first frequency.

13. The method as claimed in claim 1, wherein:
the at least one temperature data includes a plurality of temperature data of a plurality of measurement points of the electronic device, and
the DCM adjusts adaptively the updating frequency of the second image based on an average value of the plurality of temperature data.

14. A method for processing images in an electronic device which includes a graphic processor (GP), the method comprising:
displaying a first image rendered by the GP on a first window of a display panel;
displaying a third image rendered by the GP on a second window of the display panel;
collecting, by a display control module (DCM), at least one temperature data of at least one measurement point of the electronic device; and
individually adjusting, by the DCM, updating frequencies of a second image and a fourth image based on the collected at least one temperature data, wherein the second image is to be displayed on the first window subsequent to the first image and wherein the fourth image is to be displayed on the second window subsequent to the third image.

15. The method as claimed in claim 14, further comprising:
individually adjusting, by the DCM, the updating frequencies of the second image and the fourth image by delaying one of a first updating operation on the second image or a second updating operation on the fourth image, and
delaying, by the DCM, one of the first updating operation on the second image or the second updating operation on the fourth image based on a first work cycle on the first window and a second work cycle on the second window and the at least one temperature data.

16. A method for controlling a display, the method comprising:
displaying a first image;
determining a temperature of the display or a host device; and
adjusting an updating frequency of a second image based on the temperature, wherein the second image is to be displayed on the display subsequent to the first image and wherein adjusting the updating frequency includes reducing the updating frequency of the second image when the temperature is above a predetermined value, reducing the updating frequency to reduce the temperature of the host device.

17. The method as claimed in claim 16, wherein adjusting the updating frequency includes adjusting a consumption speed of the second image rendered in an internal buffer to the display.

18. The method as claimed in 16, wherein the first image is rendered by a graphic processor.

19. The method as claimed in claim 16, wherein the temperature is a temperature of the display.

20. The method as claimed in claim 16, wherein the temperature is a temperature of the host device.
